(19) United States
(12) Patent Application Publication
(10) Pub. No.: US 2008/0162734 A1
(43) Pub. Date: Jul. 3, 2008

(54) COMPUTER SYSTEM AND A CHIPSET

(76) Inventors: Keitaro UEHARA, Kokubunji (JP); Toshiomi Moriki, Kokubunji (JP); Yuji Tsushima, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/769,072

(22) Filed: Jun. 27, 2007

(30) Foreign Application Priority Data
Dec. 28, 2006 (JP) 2006-355357

(51) Int. Cl. G06F 3/00

(52) U.S. Cl. 710/3

(57) ABSTRACT

When the entire system is split into plural partitions on chipsets connecting plural processors, IO hubs, and memory controllers, and an OS is operating on each of the partitions, the present invention prevents a failure in a partition from propagating to other partitions. Based on address information or issuer information included in a packet inputted to a chipset, a partition from which the packet was issued is identified, and an identified partition identifier is added to the packet. Based on the added partition identifier, a partition initializing part selectively deletes the packet issued from the partition in which a failure occurred, thereby preventing the influence of the failure in the failure-causing partition from propagating to other partitions.

### CLAIM OF PRIORITY

The present application claims priority from Japanese Application JP 2006-355357 filed on Dec. 28, 2006, the content of which is hereby incorporated by reference into this application.

### BACKGROUND OF THE INVENTION

The present invention relates to technology for a computer system that includes plural processors and IO (Input Output) hubs, and is split into partitions, and its chipsets.

A symmetric multiple processor system (SMP) has been conventionally configured with processors, IO devices, and chipsets which are connected to each other through buses. In the case of the processors, there is an advantage that, by connecting plural processors on one processor bus, snoop processing and data transfer can be completed on the bus, while there has been a disadvantage that speeds cannot be increased. In the case of the IO devices, although plural devices can be connected on one PCI bus, there has also been a limit on an increase in speed. Accordingly, to enable higher-speed transmission, a system of one-to-one connection through on a high-speed serial interface has been adopted. For the IO devices, in place of conventional PCI buses, PCI-Express (PCI-SIG Board of Directors Approve PCI-Express Specifications for Higher-Performance Serial I/O (http://www.pcisig.com/news_room/news/press_releases/2002_{—}0 7_{—}23/2002_{—}07_{—}23.pdf)) standard has been established, and has been widely used. For the processor buses, HyperTransport (registered trademark, HyperTransport Specification 3.0 (http://www.hypertransport.org/docs/tech/HTC20051222-0046-0008-Final-4-21-06.pdf) adopted in AMD-manufactured Opteron (registered trademark) processors is a typical example of high-speed serial interface by one-to-one connection among processors.

To take advantage of high-speed serial interfaces, with improvements in chip integration, processors and the like trend to include functions of conventional chipsets. For example, in the case of the conventional configuration of processor buses plus chip sets, the functions of cache controllers and memory controllers included in north bridge chipsets are included in processors of one-to-one connection such as AMD-manufactured Opteron. By enabling direct access to memories and caches of other processors without going through chipsets, the latency of memory access can be reduced, and the benefits of memory throughput by high-speed serial interfaces can be obtained to the fullest possible extent. Likewise, the functions of IO device interfaces included in conventional south bridge chipsets tend to be integrated in IO hub chips. As a result, even third vendors that have difficulty in manufacturing chips including high-speed serial interfaces can configure servers by offering processors and IO hub chips as commodities. As a result, server platforms themselves are put into commodities, reduced in cost, and will be more widely used.

In platforms with processors and IO hub chips thus put into commodities, to configure a larger-scale SMP, chipsets having switching functions by high-speed serial interfaces are required. The chipsets convey request packets issued from connected processors (cores) and IO hubs to desired processors (cores) and IO hubs or memory controllers, and convey response packets (read data, write completion notification, or error report) issued as a result to issuing processors (cores) and IO hubs.

On the other hand, with improvements in the performance of recent computers, particularly with the advance of a multi-core version of processors, attempts are often made to reduce costs by performing processings having been distributed among plural servers collectively in one server. Effective means for such collective processing is to run plural operating systems on one server by splitting the server. Server splitting methods include a physical splitting method that supports splitting by hardware in units of nodes or components such as processors (cores) and IO devices, and a logical splitting method achieved by a hypervisor and firmware referred to as virtualizing software. By the logical splitting method, each operating system (guest OS) is executed on a logical processor offered by the hypervisor, and plural logical processors are mapped into physical processors by the hypervisor, whereby partitions can be split in units smaller than nodes. Furthermore, as for processors (cores), processing can be performed while switching one physical processor (core) in time-division mode among plural logical partitions. By this method, more logical partitions than the number of physical processors (cores) can be created for concurrent execution. VMware (registered trademark, U.S. Pat. No. 6,496,847) is a typical example of server virtualizing software intended for logical splitting. Intel-established VT-d (Intel Virtualization Technology for Directed I/O Architecture Specification (http=//www.intel.com/technology/computing/vptech/)) is a function to support logical splitting including IOs by providing IO hubs with a function to convert and protect DMA addresses when the IOs are used in plural OSes.

### BRIEF SUMMARY OF THE INVENTION

Consider the case where plural OSes are executed by server splitting on a large-scale symmetric multiple processor system in which connections are made by chipsets having the switching function as described previously.

An important point in server splitting is to ensure reliability and availability of each portion of a split server. Particularly, when a failure occurs in a server of a certain partition, possible influence on servers in other partitions would significantly reduce reliability and availability in comparison with cases where server splitting is not made.

Therefore, in a chipset having the above-described switching function, it is important to prevent the influence of a server failure in a certain partition from propagating to other partitions. Since packets utilizing plural paths pass through switches on the chipset, resources on the chipset such as queues and buffers may be used in common from plural partitions. Consider the case where packets belonging to plural partitions are queued. Assume that a server belonging to a specific partition fails and related links have been disabled for transmission. If the queue has the FIFO (First-In First-Out) structure and a packet in the head of the queue belongs to the failed partition, the packet continues to stay in the head without being processed. Although the packet is soon deleted as failure due to timeout, succeeding packets belonging to other partitions are also forced to wait for the timeout period, so that a chain of timeouts may be caused. Even if the structure of the queue is not FIFO but Out-of-Order so that succeeding unrelated packets are pulled out, it is undesirable that packets belonging to the failed partition exclusively use resources before timeout, causing substantial reduction in performance.

An object of the present invention is to provide a computing system that minimizes the influence of failure in a partition in the environment in which plural OSes are executed by server splitting on a large-scale symmetric multiple processor system in which connections are made by chipsets having the switching function.

The following describes the configuration of the present invention.

The present invention takes a symmetric multiple processor configuration in which plural processors, IO hubs, and memory controllers are connected by chipsets. The components are connected by links. The symmetric multiple processor is split into plural partitions, and an OS is run on each partition. Splitting into partitions may be made in units of components or in smaller units (processor core, IO bus connected to IO hub, or IO device). A single processor core and IO device may be used at the same time among plural partitions (shared in time-division mode). The chipsets function as bus switches for connecting the components. A reverse consultation mode of partition identifiers can be set correspondingly to each link of the chipsets. The chipsets include a node setting control unit that manages settings in units of chipsets, and a system setting control unit manages the entire system.

The following describes the operation of the present invention. Before the system is started, the structure of partition splitting of the entire system is decided. When the structure of partition splitting is inputted from a setting console, according to the structure, a reverse consultation mode of partition identifiers corresponding to each link connected to the components is set. When a partition can be uniquely located by an issuer NodeID in units of processor cores and or IO hubs, TxID reverse consultation mode is used. When a partition can be uniquely located by an issuer NodeID, such as when plural partitions coexist via IO hubs and IO bridges, or when a processor core is shared in time-division mode, address reverse consultation mode is used. When chipsets exist ahead of a link, non-conversion mode is used. By performing settings as described above, the chipsets function as a partition identifier adding unit, and can add partition identifiers for request packets coming from processors and IO hubs.

The following describes troubleshooting by use of partition identifiers of the present invention. When a failure in a specific partition is detected, failure information is passed to the node setting control unit of each chipset via the system setting control unit. The node setting control unit commands a partition initializing unit corresponding to each link to delete packets belonging to the failure-causing partition. The partition initializing unit checks a partition identifier of a head entry of the reception queue, and deletes it if it belongs to the partition to be initialized, thereby quickly releasing resources used by packets in the failed partition.

The present invention prevents resources of a chipset shared among plural partitions from being occupied by a failure-causing partition, and prevent failure propagation due to a chain of timeouts.

Partition identifiers can be used for purposes other than troubleshooting. For example, by preferentially allocating resources to packets belonging to a specific partition or limiting them, express path can be formed, or application can be made to flow control and QoS control.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a chipset of a first embodiment of the present invention;

FIG. 2 is a drawing showing the structure of a packet in a first embodiment;

FIG. 3 is a drawing showing the structure of a packet in a first embodiment;

FIG. 4 is a drawing the structure of a header unit in a first embodiment;

FIG. 5 is a drawing the structure of a header unit in a first embodiment;

FIG. 6 is a drawing the structure of an extended header unit in a first embodiment;

FIG. 7 is a drawing showing a concrete example of Tx type in a first embodiment;

FIG. 8 is a drawing showing a concrete example of TxID configuration in a first embodiment;

FIG. 9 is a drawing showing the structure of a TxID reverse consultation table in a first embodiment;

FIG. 10 is a drawing showing the structure of an address reverse consultation table in a first embodiment;

FIG. 11 is a drawing showing the structure of a simplified version of an address reverse consultation table in a first embodiment;

FIG. 12 is a drawing showing the structure of a request/response reverse consultation table in a first embodiment;

FIG. 13 is a block diagram of a partition initializing unit in a first embodiment;

FIG. 14 is a block diagram of an address conversion unit in a first embodiment;

FIG. 15 is a drawing the structure of a simplified version of an address conversion unit in a first embodiment;

FIG. 16 is a block diagram of an IO hub in a first embodiment;

FIG. 17 is a block diagram of an I/O address conversion unit in a first embodiment;

FIG. 18 a block diagram of a system in a first embodiment;

FIG. 19 is a drawing showing partition setting in a first embodiment;

FIG. 20 is a drawing showing the configuration of a IO hub in a variant of the first embodiment;

FIG. 21 is a drawing showing partition setting in a second embodiment of the present invention;

FIG. 22 is a flowchart of processing in a transmitting side for a reverse consultation table included in a partition identifier assigning unit in a first embodiment; and

FIG. 23 is a flowchart of processing in a receiving side for a reverse consultation table included in a partition identifier assigning unit in a first embodiment

### DETAILED DESCRIPTION OF THE INVENTION

Hereinafter, embodiments of the present invention will be described with reference to the accompanying drawings.

### First Embodiment

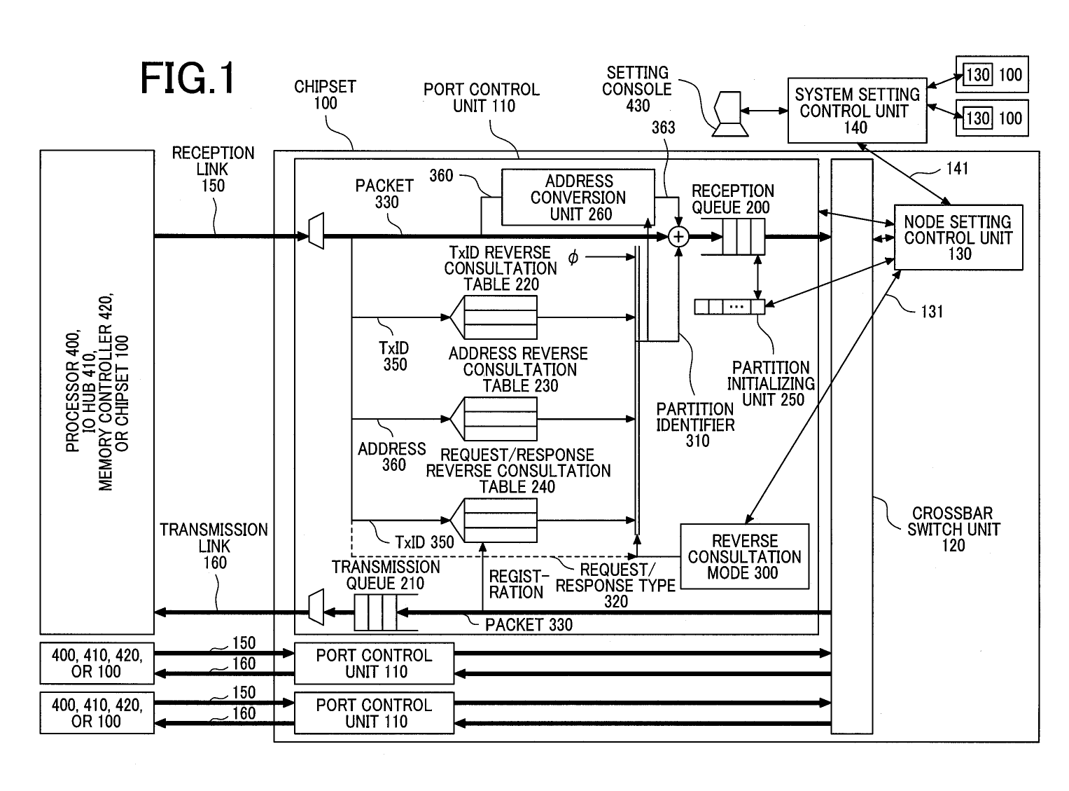

FIG. 1 is a schematic diagram showing the configuration of a chipset 100 having a partition identifier adjunct to do the basis of the first embodiment.

The chipset 100 has plural pairs of reception links 150 and transmission links 160. Since the reception links 150 and transmission links 160 seems reverse to opposite components, a pair of each two of them is referred to as a transmission/reception link 155. In the chipset 100, a portion to which each transmission/reception link is connected is referred to as a port. The chipset 100 is connected to components different from each other in units of ports. Conceivable components include a processor 400, an IO hub 410, a memory controller 420, or another chipset 100. The processor 400 may include plural processor cores 401. The memory controller 420 may be included in the processor 400. The IO hub 410 includes one or more IO buses 411 (PCI buses and PCI-Express buses), which have one or more IO cards 412 and IO devices 413 connected ahead of them.

The chipset 100 includes port control units 110 each corresponding to each port, a crossbar switch unit 120 that exchanges packets between ports, and a node setting control unit 130 that performs various settings related to the chipset 100. The node setting control unit 130 is connected with a system setting control unit 140 that performs settings of the entire system via a management bus 141 (although an exclusive link is shown in the drawing, a transmission/reception link may be shared). A manager can change and manage settings of the entire system and each chipset as a node unit by accessing the system setting control unit 140 via a setting console 430. The system setting control unit 140 includes a normal service processor, and the node setting control unit 130 includes a normal board management controller (BMC).

The port control unit 110 includes a receiving unit including a reception queue 200 that stores a packet 330 coming from the reception link 150, and a transmitting unit including a transmission queue 210 that stores a packet 330 to be transmitted to the transmission link 160. The packet receiving unit includes, in addition to the reception queue 200, plural reverse consultation tables 220 to 240, an address conversion unit 260, and a partition initializing unit 250. Furthermore, it includes a reverse consultation mode 300.

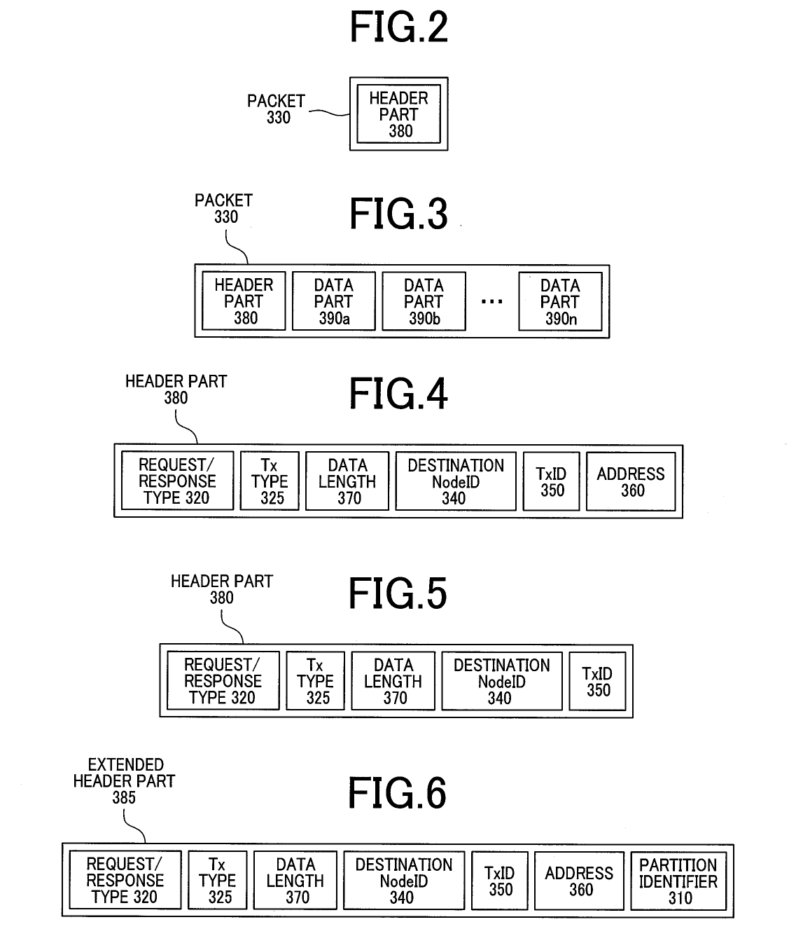

FIGS. 2 to 6 show concrete structures of packets 330. The packets 330 have a header unit 380. The packets 330 include packets having data (write request, read result, etc.) and packets having no data (write completion and read request); the difference between them can be determined by examining the header unit 380. FIG. 2 shows a packet 330 having no data, which consists of only the header unit 380. FIG. 3 shows a packet 330 having data, which has the header unit 380 followed by plural data units 390.

FIG. 4 shows an example of the structure of the header unit 380 including an address. The header unit 380 includes a request/response type 320, Tx (transaction) type 325, data length 370, destination NodeID 340, TxID 350, and address 360. FIG. 5 shows an example of the structure of the header unit 380 including no address; the header unit 380 of FIG. 5 is the same as that of FIG. 4, except that it includes no address. These header units 380, which do not include a partition identifier for identifying partitions, serve as an extended header unit 385 as shown in FIG. 6 when added with a partition identifier 310.

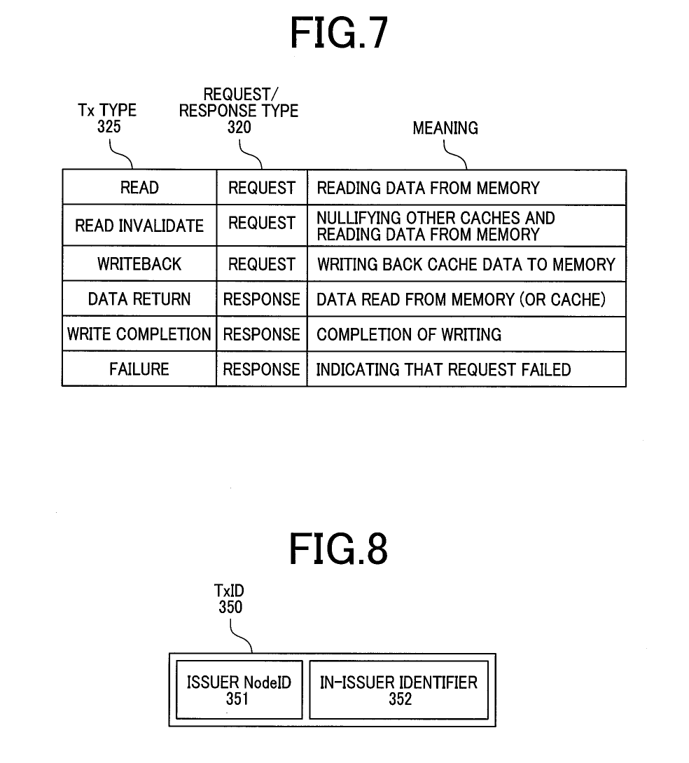

FIG. 7 shows typical transaction types as examples of Tx type 325. Conceivable Tx belonging to “request” include Read, Read Invalidate, Writeback, and the like. On the other hand, conceivable Tx belonging to “response” include Data Return corresponding to Read and Read invalidate, Write Completion corresponding to Writeback, Failure indicating failure, and the like. Of course, besides these, various Tx such as Tx for snooping cache are conceivable.

FIG. 8 shows an example of the structure of TxID 350. TxID 350 is a transaction identifier for uniquely identifying transactions in a system. As shown in FIG. 8, TxID generally includes a pair of issuer NodeID 351, and in-issuer identifier 352.

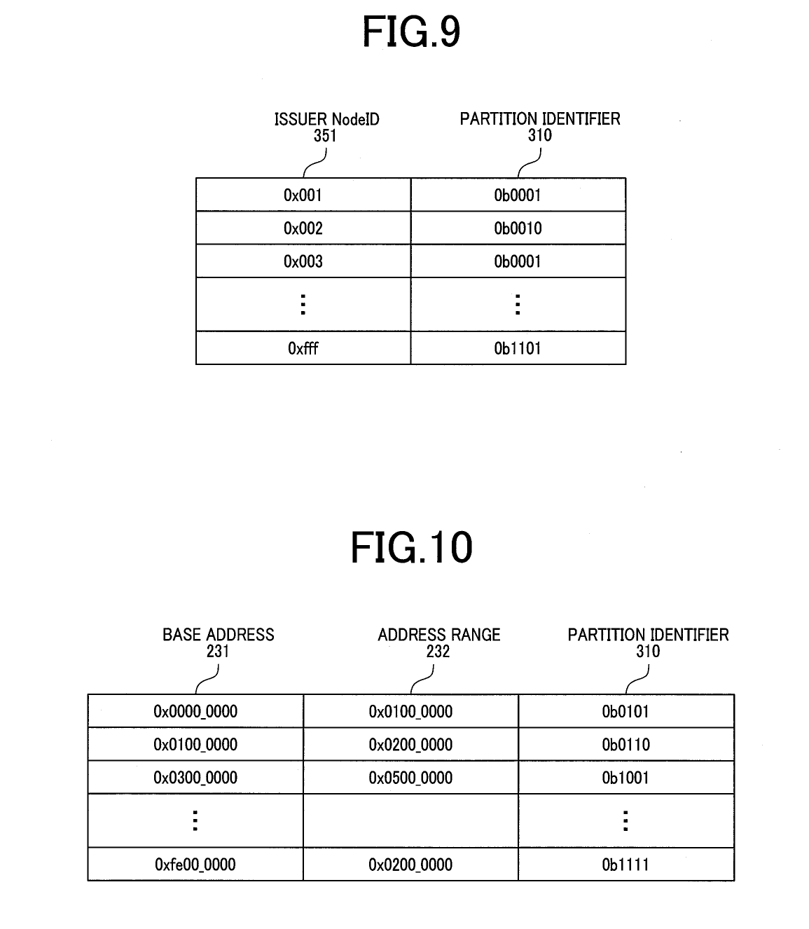

FIGS. 9 to 12 show examples of the structures of reverse consultation tables constituting a partition identifier adding unit. The reverse consultation tables include a TxID reverse consultation table 220, an address reverse consultation table 230, and a request/response reverse consultation table 240. According to a preset reverse consultation mode 300, and a request/response type 320 included in a received packet 330, an appropriate table or non-conversion is selected, and a partition identifier 310 is created. The created partition identifier 310 is embedded in the extended header unit 385 of the packet 330 and sent to the reception queue 200. The reverse consultation mode 300, which consists of, for example, a two-bit register, is set to a bit value corresponding to a mode in the each board control unit 110.

The TxID reverse consultation table 220 is used when a partition identifier 310 is uniquely determined from the issuer NodeID 351. For example, it is used in a case where an issuer NodeID is added in units of processor cores, and the system is split into partitions in units of processor core units, or in a case where all IO buses under IO hub control belong to one partition. As shown in FIG. 9, each entry of the TxID reverse consultation table 220 consists of a pair of issuer NodeID 351 and partition identifier 310.

The address reverse consultation table 230 is used in a case where a partition identifier 310, without being uniquely determined from an issuer NodeID 351, must be obtained using an address 360. For example, it is used in a case where a processor core is shared in time-division mode among plural partitions, or a case where IO devices belonging to plural partitions IO exist under control of an IO hub and an IO bridge, and issuer NodeID 351 is reassigned by the IO hub and the IO bridge. As shown in FIG. 10, each entry of the address reverse consultation table 230 includes a base address 231, an address range 232, and a partition identifier 310. If a pertinent address is not included in an entry corresponding to the partition identifier 310, by generating an error as access violation, illegal memory access due to IO device runaway can be prevented.

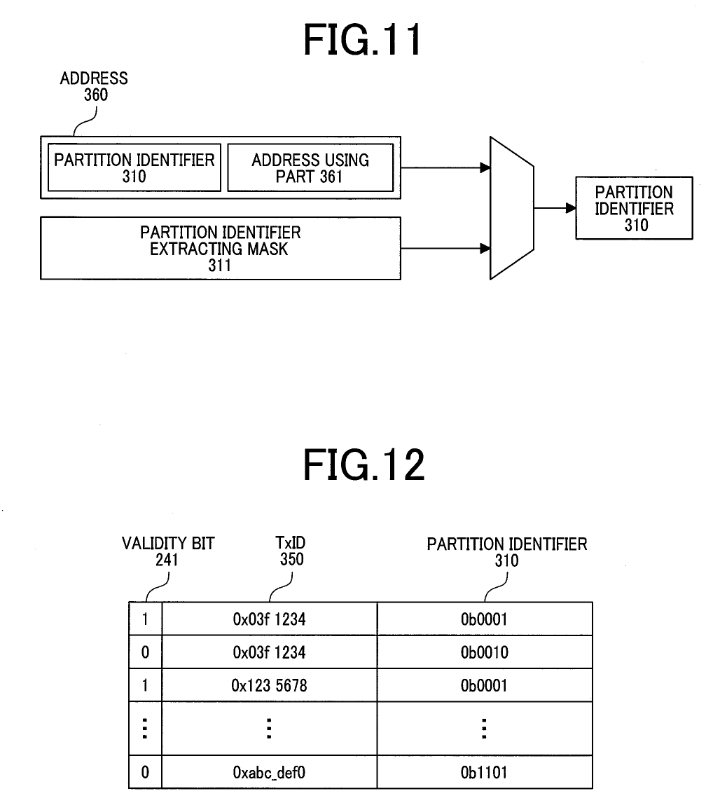

As another method, the structure of the address reverse consultation table 230 may be made simpler. Often, upper bits of an address 360 are not used. This is because there is a limit on the amount of a mounted physical memory. Accordingly, as shown in FIG. 11, a partition identifier 310 is directly embedded in upper bits of the address 360, and can be fetched by simply performing a simple bit operation on a partition identifier extracting mask 311. A method of embedding the partition identifier 310 in upper bits of the address 360 will be described when the structure of the IO hub 410 is described.

The request/response reverse consultation table 240 is when a request packet 330 added with the partition identifier 310 is transmitted to the processor 400, IO hub 410, or memory controller 420 from the transmitting unit, and a response packet 330 corresponding to it is received in the receiving unit. Since an address 360 may not be included in the header unit 380 of the response packet, and a partition identifier 310 is effective only in the chipset 100, a partition identifier 310 included in the request packet must be held to reassign the partition identifier to a corresponding response packet.

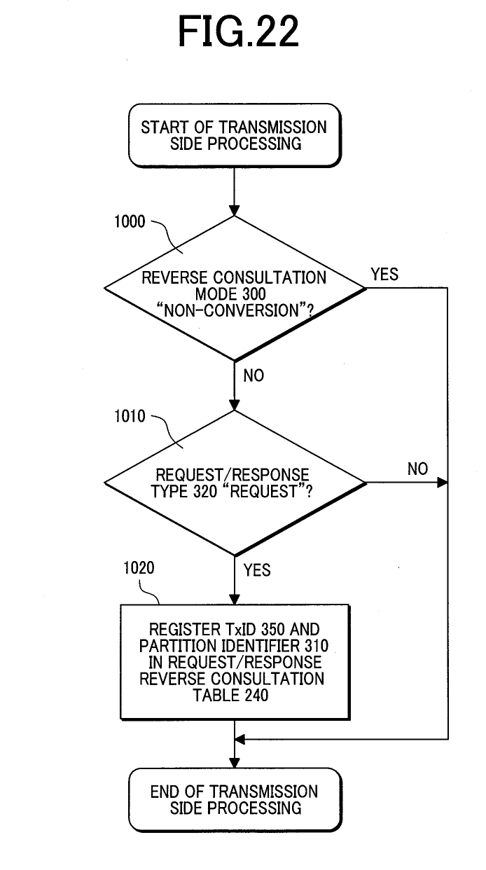

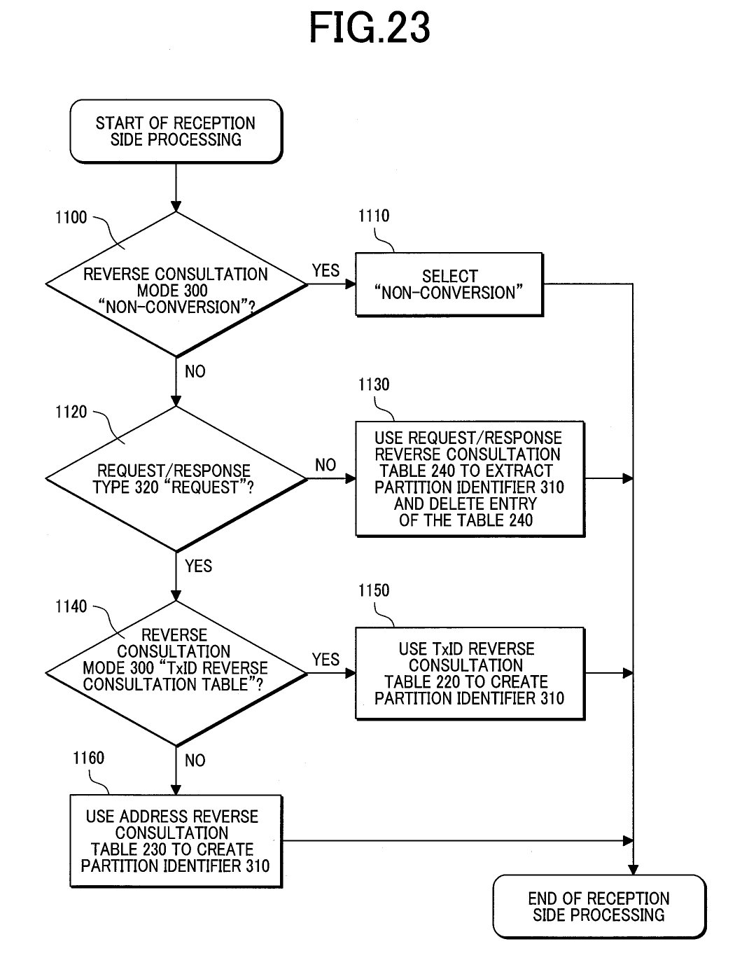

FIGS. 22 and 23 show processing flowcharts related to the reverse consultation table constituting a partition identifier adding unit. FIG. 22 is a processing flowchart in a transmitting side. Step 1000 determines the reverse consultation mode 300 by checking a bit value set in a register. When the reverse consultation mode 300 is “non-conversion”, it proceeds without doing anything. Otherwise, it proceeds to Step 1010.

Step 1010 checks a request/response type 320 included in the packet 330. For “request”, it proceeds to Step 1020. Otherwise, it proceeds without doing anything. In Step 1020, TxID 350 and a partition identifier 310 are stored in the request/response reverse consultation table 240. This terminates the processing in the transmitting side.

FIG. 23 is a processing flowchart of a receiving side. Step 1100 checks the reverse consultation mode 300. When the reverse consultation mode 300 is “non-conversion”, it proceeds to Step 1110. Otherwise, it proceeds to Step 1120. Step 1110 stores the packet in the reception queue 200, and the processing terminates.

Step 1120 checks a request/response type 320 included in the packet 330. For “request”, it proceeds to Step 1140. For “response”, it proceeds to Step 1130.

Step 1130 uses the request/response reverse consultation table 240 to extract a partition identifier 310. A corresponding entry is deleted from the request/response reverse consultation table 240. A partition identifier 310 is added to the packet 330, the packet 330 is stored in the reception queue 200, and the processing terminates.

Step 1140 checks the reverse consultation mode 300. When the reverse consultation mode 300 indicates “TxID reverse consultation table 220”, it proceeds to Step 1150. When the reverse consultation mode 300 indicates “address reverse consultation table 230”, it proceeds to Step 1160.

Step 1150 uses the TxID reverse consultation table 220 to create a partition identifier 310. The partition identifier 310 is added to the packet 330, the packet 330 is stored in the reception queue 200, and the processing terminates.

Step 1160 uses the address reverse consultation table 230 to create a partition identifier 310. The partition identifier 310 is added to the packet 330, the packet 330 is stored in the reception queue 200, and the processing terminates.

The above is an operation flow on partition identifier creation by use of reverse consultation tables constituting the partition identifier adding unit.

FIG. 14 shows the structure of the address conversion unit 260 in the chipset 100 shown in FIG. 14. The address conversion unit 260 gets an address 360 and a partition identifier 310 to create a post-conversion address 363. When the address 360 matches a base address 261 and an address range 262 that correspond to the partition identifier 310, a post-conversion base address 263 is used as the post-conversion address 363.

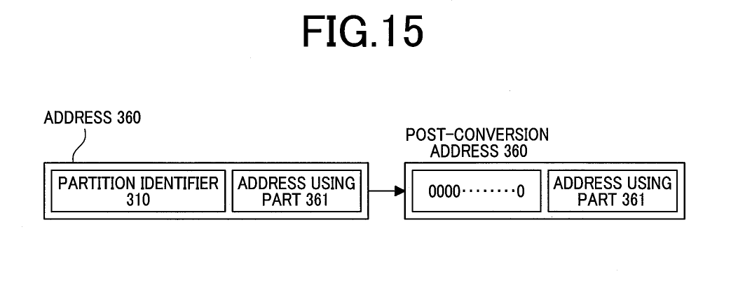

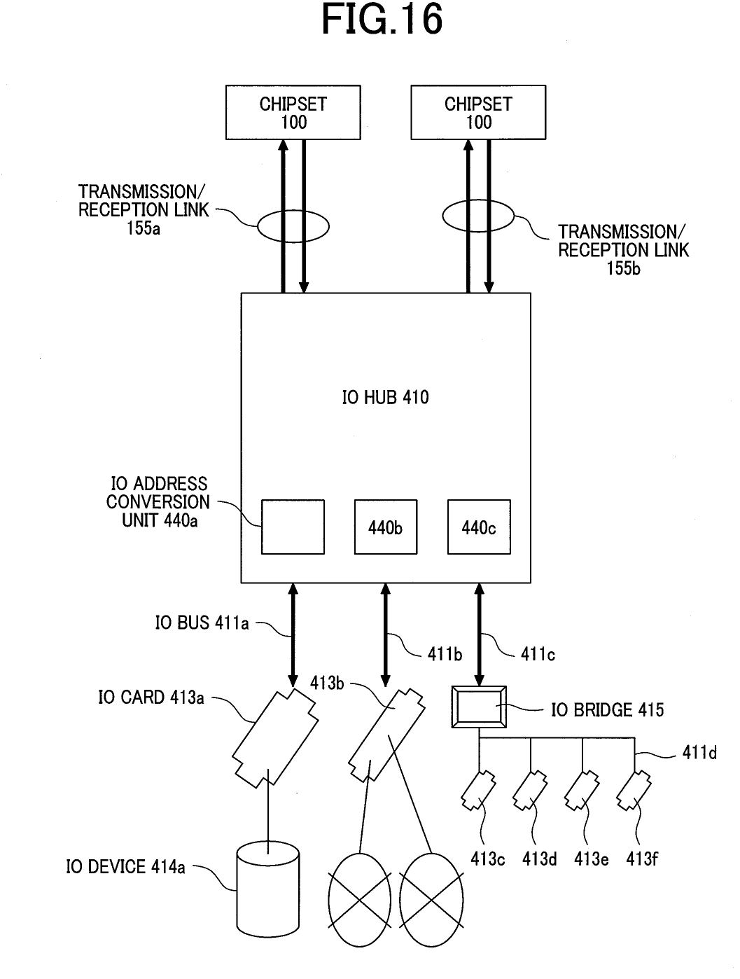

FIG. 15 shows the structure of a simplified version of the address conversion unit 260 corresponding to the simplified version of the address reverse consultation table 230 of FIG. 11. When a partition identifier 310 is embedded in upper bits of the address 360, a post-conversion address 363 can be created simply by removing the partition identifier 310 portion and embedding all zeros in the vacated portion.

FIG. 16 shows a concrete example of the structure of the IO hub 410. The IO hub 410 has one or more pairs of transmission/reception links 155 for connection with the chipset 100 and one or more IO buses 411 for connecting IO cards and IO devices. IO cards 413 are connected ahead of IO buses 411, and one or more IO devices 414 are connected ahead of the IO cards 413. The IO buses 411 can be further branched to plural buses by an IO bridge 415, and plural IO cards 413 (and IO devices 414) can be connected under one IO bus 411.

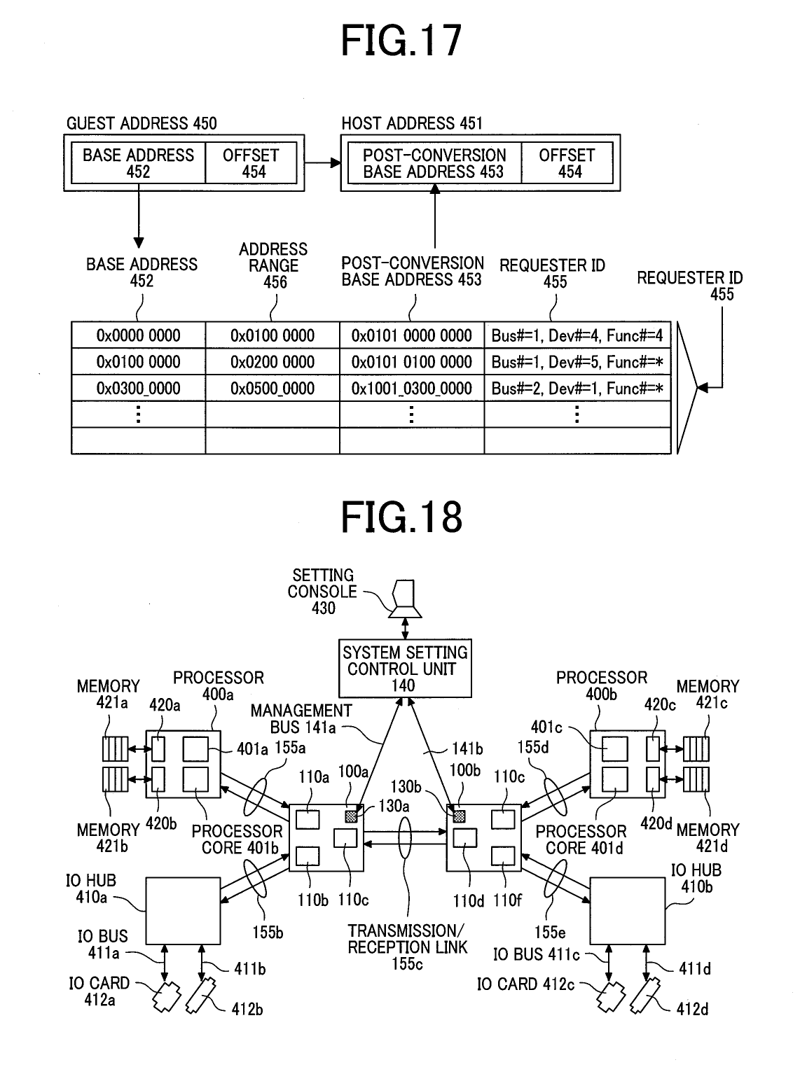

The IO hub 410 can include an IO address conversion unit 440. FIG. 17 shows an example of the structure of the IO address conversion unit 440. The IO address conversion unit 440 converts a guest address 450 included in an IO transaction passing through the IO bus into a host address 451. By this mechanism, when the system is split into partitions and plural OSes are operating, even if the ranges of address areas (guest addresses) used by the OSes overlap, appropriate address conversion can be performed. For the address conversion, a requester ID 455 included in the IO transaction is used. The requester ID 455 includes a bus number, a device number, and a function number in the case of PCI-Express being a typical IO bus. Information on the requester ID 455 is used in the IO hub 410, and may not be included in the packet 330 passing through the transmission/reception link 150/160. When an address is not included in a corresponding entry, by generating an error as access violation, illegal memory access due to IO device runaway can be prevented.

In the above-described IO address conversion unit 440, as a converted host address 451, as described previously, by directly embedding a partition identifier in its upper bits, a simpler address reverse consultation table can be formed in the chipset side.

In the description of the embodiment of the address conversion unit, the IO address conversion unit 440 of the IO hub 410 is shown as an example. However, also in the case of a processor, it goes without saying that a function to convert address information is provided according to a partition to which a processor core being a packet issuer belongs.

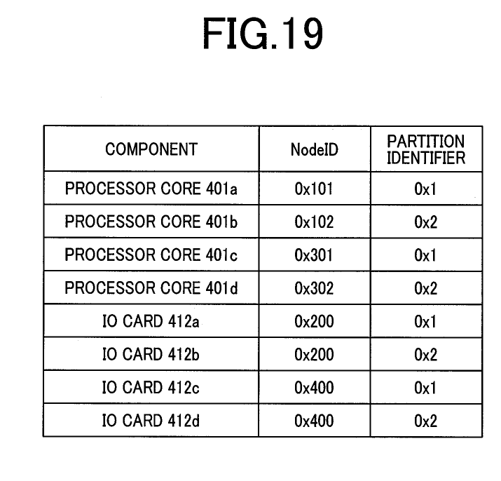

FIG. 18 is a schematic diagram showing an example of the configuration of the entire system in the first embodiment. In the system, two processors 400, two IO hubs 410, and two chipsets 100 are mutually connected by five pairs of transmission/reception links 155. Each processor 400 includes two processor cores 401 and two memory controllers 420. Each IO hub 410 has two IO buses 411, each of which has IO cards 412 connected ahead of it (IO devices 414 are omitted in the drawing). The entire system is split into two partitions, and as shown in a table of FIG. 19, two processor cores 401 included in each processor 400 and two IO cards 412 connected to each IO hub 410 are split into two partitions (partition identifiers 0x1 and 0x2). The chipsets 100 each include a node setting control unit 130, which is connected to the system setting control unit 140 via the management bus 141. The manager can access the system setting control unit 140 through the setting console 430.

The following describes a method of setting the port control units 110 of the chipsets 100 in this configuration. As for port control units 110a and 110e connected with processors 400a and 400b, since partitioning is made in units of processor cores 401, a partition can be uniquely located by an issuer NodeID 351 indicated by TxID 350 included in the request packet 330. Therefore, as for these ports, the register of the reverse consultation mode 300 is set to use the TxID reverse consultation table 220.

On the other hand, as for port control units 110b and 110f connected with IO hubs 410a and 410b, the TxID reverse consultation table 220 cannot be used. This is because, as shown in FIG. 19, since one NodeID is assigned to the entire hub 410a, the chipset 100 cannot distinguish between IO cards 412a and 412b. Therefore, as for these ports, the register of the reverse consultation mode 300 is set to use the address reverse consultation table 230 that identifies partitions from addresses.

Finally, as for port control unit 110c and 110d that connect chipsets 100a and 100b, it can be expected that partition identifiers are already assigned in entrance ports. Therefore, as for these ports, the register of the reverse consultation mode 300 is set to perform no conversion.

The following describes operation from the issuance of Tx to the return of results in the example of FIG. 18. First, a description is made of the case where a Read request is issued from a processor core 401a to a memory 421c. The port control unit 110a of the chipset 100a receives a packet 330. It is determined from the header unit 380 of the packet 330 that the packet 330 is a request packet. Since a setting value of the reverse consultation mode 300 indicates that the TxID reverse consultation table 220 should be used for the request packet, 0x1 is obtained as a partition identifier 310. The partition identifier 310 is stored in the header unit 380 to form an extended header unit 385, and then stored in the reception queue 200. The address conversion unit 260 of the port control unit 110a is set to perform no conversion.

Since a destination is a transmission/reception link 155c, the packet is sent to the port control unit 110c via the crossbar switch unit 120. Since the reverse consultation mode 300 is set as non-conversion, the port control unit 110c sends the packet to the transmission/reception link 155c with no operations on the packet, and the packet is sent to the chipset 100b.

The port control unit 110d of the chipset 100b receives the packet 330. Since the reverse consultation mode 300 is set as non-conversion, it stores the packet in the reception queue 200 with no operations on the packet.

Since a destination is a transmission/reception link 155d, the packet is sent to the port control unit 110e via the crossbar switch unit 120. In the port control unit 110e, the reverse consultation mode 300 is set to use the TxID reverse consultation table 220. In this case, however, since the port control unit 110e is the transmitting side, it registers TxID 350 and partition identifier 310 included in the packet 330 in the request/response reverse consultation table 240, and sets a validity bi 241 to 1. The packet is put in the transmission queue 210, and sent to a memory controller 420c on the processor 400b via the transmission/reception link 155d. Since components other than the chipset 100 do not use the partition identifier 310, before issuing the packet, the partition identifier 310 may be removed from the extended header unit 385 and returned to the header unit 380.

When data has been read out from a memory 421d, a response packet 330 including the read-out data is sent to the port control unit 110e of the chipset 100b via the transmission/reception link 155d. On recognizing that the reverse consultation mode 300 is not non-conversion, and the request/response type 320 included in the packet 330 indicates response, the port control unit 110e attempts partition identification by using the request/response reverse consultation table 240. It fetches a partition identifier 310 of an entry with the validity bi 241 set to 1 that matches TxID 350 included in the response packet 330, and stores the partition identifier 310 in the extended header unit 385 of the response packet 330. When the request and the response match, the validity bi 241 of the pertinent entry of the request/response reverse consultation table 240 is cleared to 0.

The response packet 330 added with the partition identifier 310 reaches the port control unit 110a through the port control unit 110d, the transmission/reception link 155c, and the port control unit 110c. The port control unit 110a removes the partition identifier 310 from the extended header unit 385, returns it to the header unit 380, and then transmits it to the transmission/reception link 155a. The processor core 401a receives the response packet 330, and thus completes the issuance of Read.

The following describes operation at the time of the issuance of a Read request from the IO card 412b to the memory 421d. The port control unit 110b of the chipset 100a receives a packet 330. On recognizing that the reverse consultation mode 300 of the port control unit 110b is set to the address reverse consultation table 230, and the request/response type 320 included in the packet 330 indicates request, the port control unit 110b obtains a partition identifier by using the address reverse consultation table 230. In this case, a simplified version of the address reverse consultation table 230 is used in which a partition identifier 310 is embedded in upper bits of the address 360 by the IO address conversion unit 440 of the IO hub 410. A partition identifier 310 is extracted by a bit operation on the partition identifier extraction mask 311. On the other hand, by the address conversion unit 360, the upper bits in which the partition identifier 310 has been embedded are filled with zeros for conversion into the original address. The extracted partition identifier 310 is embedded in the extended header unit 385, and stored in the reception queue 200.

Operation after the partition identifier 310 has been added is the same as the case of a transaction issued from a processor core; its description is omitted.

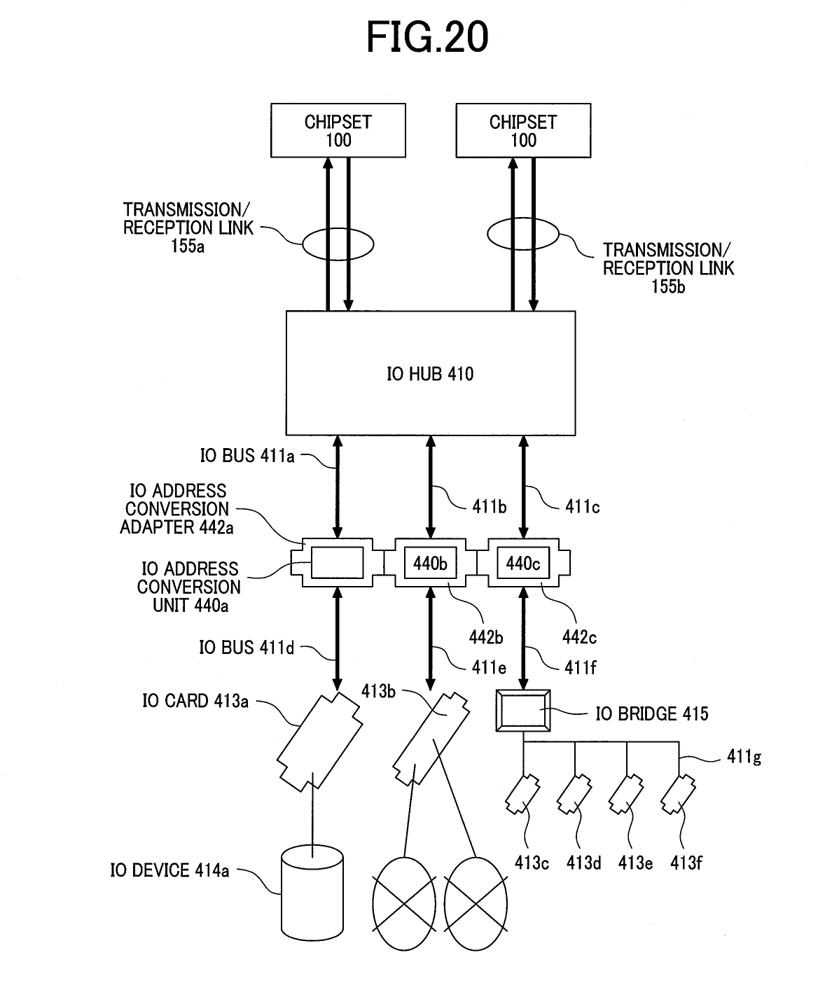

FIG. 20 shows a variant of the first embodiment. In this example, IO address conversion units 440 included in the IO hub 410 are expelled from the IO hub 410, and independent as IO address conversion adaptors 442. The IO address conversion adaptors 442 are located between IO cards 413 and the IO hub 410, and convert the guest addresses of IO transactions coming from the IO cards into host addresses. When seen from the chipset 100, operation is the same between when the IO address conversion units 440 are in the IO hub 410, and when they are in the IO address conversion adaptors 442; a detailed description of operation is omitted.

### Second Embodiment

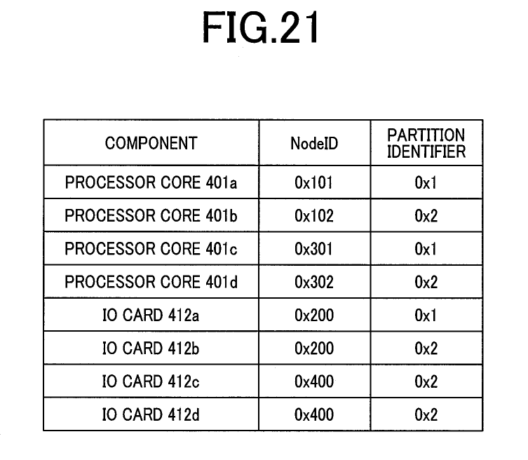

The following describes the operation of troubleshooting by use of partition identifiers as a second embodiment. FIG. 18 is used again as a system configuration diagram. As a partition splitting method, as shown in FIG. 21, it is assumed that all IO hubs 410b belong to a partition 0x2.

Assume that a failure occurs in the IO card 412a under the IO hub 410b, and packet reception has been disabled. Soon, the transmission/reception link 155e is congested with packets destined for the IO card 412d, and the transmission queue 210 of the port control unit 110f becomes full. As a result, packets destined for the port control unit 110f stored in the reception queue 200 of the port control unit 110d will soon become unable to be issued.

A problem is that the reception queue 200 of the port control unit 110d may contain not only packets 330 belonging to the failing partition 0x2 but also packets 330 belonging to the failure-free partition 0x1. If the packets 330 belonging to the partition 0x2 continue to stay in the reception queue 200, since succeeding packets 330 belonging to the partition 0x1 cannot be transmitted, a timeout will soon be detected in an issuing component and a failure will occur. This is an undesirable example of propagation of failure in a certain partition (0x2) to another partition (0x1).

The following describes a procedure for containing failure within a partition by using the partition initializing unit 250 in the second embodiment. The system setting control unit 140 detects by some method that failure occurs in the IO card 412d. Normally, the service processor includes such a failure detection function; available methods include failure detection notification from the IO hub 410b and timeout detection in the chipset 100b. Here, an example of timeout detection is shown. Normally, BMC constituting the node setting control unit 130b in the chipset 100b includes such a time-out detection function.

A packet 330 destined for the failed IO card 412d is put in the head of the reception queue 200 of the port control unit 110d. Since the transmission queue 210 of the port control unit 110f being a destination is flooded with packets that cannot be transmitted, the packet continues to stay in the head, so that timeout will soon be detected. When timeout is detected, a partition identifier 310 (0x2 in this case) included in the head packet is notified to the node setting control unit 130b. The timeout-causing packet 330 is removed, and succeeding packets 330 are processed. However, when a packet destined for the port control unit 110f exists again in the succeeding packets, the system will stop again.

The node setting control unit 130b reports timeout detection and the partition identifier 310 of the timeout-causing packet to the system setting control unit 140 via the management bus 141. The system setting control unit 140 determines from the reported failure information that the partition 0x2-caused the failure, and commands all the chipsets 100 to initialize the partition 0x2. On receiving the command, the node setting control units 130a and 130b perform settings for the partition initializing unit 250 of each port control unit 110 via the register access interface 131. The register access interface 131 is constructed based on, for example, Joint Test Action Group (JTAG) and System Management Bus (SMBUS).

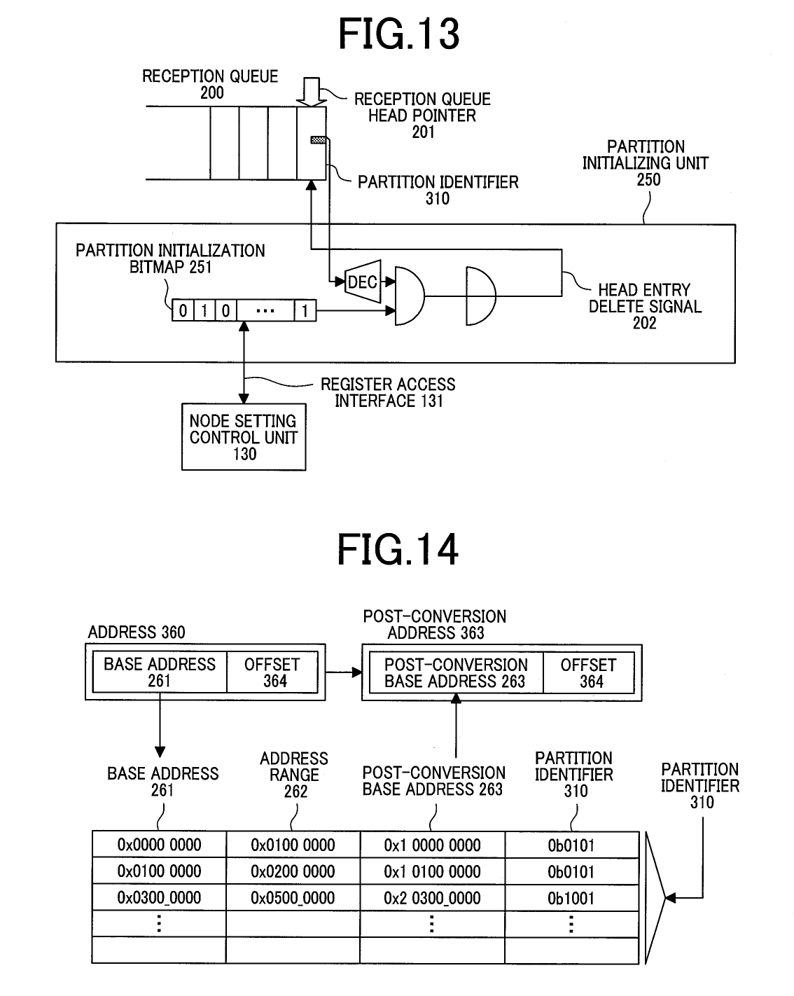

FIG. 13 shows the structure of the partition initializing unit 250. The partition initializing unit 250 has a partition initialization bitmap 251, and sets a bit corresponding to the partition to be initialized (0x2 in this case) to 1. The partition identifier 310 of a head packet 330 of the reception queue 200 is compared with the partition initialization bitmap 251. If the packet 330 belongs to the partition to be initialized, a head entry delete signal 202 is generated and the packet is quickly removed. This prevents succeeding packets of unrelated partitions from causing timeout as a result of not releasing resources.

The system setting control unit 140, after sufficient elapse of time required to complete the deletion of packets, again commands the node setting control units 130 to complete partition initialization. The node setting control units 130 clear the corresponding bit of the partition initialization bitmap 251 to 0 and complete the partition initialization. As methods of ensuring the completion of packet deletion, besides the above-described method of waiting for sufficient time, a conceivable method is to count the number of packets for each partition at the entrance of the reception queue, and decrease the counter for each deletion, and make notification when the counter reaches zero.

The above is the operation of troubleshooting by use of partition identifiers in the second embodiment of the present invention. Although the example shown here adds partition identifiers 310 in the chipset 100 like the first embodiment, troubleshooting and partition initialization of the second embodiment can apply independently of the first embodiment. Specifically, even when a partition identifier 310 is included from the first in a packet 330 issued by the processors 400 and the IO hubs 410, the troubleshooting described in the second embodiment can be applied.

As has been detailed above, the present invention can apply to a computer system that includes plural processors and IO hubs, and is split into partitions, and its chipsets, and can provide effective solution technology for failure propagation among partitions.

What is claimed is:

1. A computing system comprising:
a processor including a processor core,
an IO hub including a link connecting an IO device; and
a memory controller including a memory, the processor, the IO hub and the memory controller being mutually connected by a chipset,
wherein: the computing system is split into one or more partitions in each of which a virtual computer with an operating system run is operated, and the processor core or the IO device respectively belongs to the partitions; and
the chipset includes:
a receiving unit that receives a packet issued from the processor core or the IO device, the packet having address information or issuer information; and
a partition identifier adding unit that identifies, based on the address information or the issuer information, the partitions to which the processor core or the IO device that issued the packet belongs, and adds a partition identifier corresponding to the identified partition to the packet.

2. The computing system according to claim 1,
wherein: the chipset includes a transmitting unit that transmits a request packet to request access to the processor core, the IO device, or the memory controller;
the partition identifier adding unit, when the transmitting unit transmits the request packet, registers a transaction identifier and a corresponding partition identifier included in the request packet; and
the partition identifier adding unit, when address information or issuer information is not included in a response packet received in response to the request packet, associates the request packet and the response packet by the transaction identifier and adds the corresponding partition identifier to the response packet.

3. The computing system according to claim 1,
wherein: the processor or the IO hub converts the address information according to the partitions to which the processor core or the IO device of an issuer of the packet belongs; and
the partition identifier adding unit identifies the partition identifier from the address information included in the packet.

4. The computing system according to claim 3,
wherein: the processor or the IO hub embeds the partition identifier in an upper bit of an address when converting the address information according to the partitions; and
the partition identifier adding unit extracts the partition identifier from the upper bit in the address information.

5. The computing system according to claim 1, further comprising:
an address conversion unit that converts the address information according to the partitions to which the IO device of an issuer of the packet belongs, in the link connecting the IO hub and the IO device,
wherein the partition identifier adding unit obtains the partition identifier from the address information included in the packet.

6. The computing system according to claim 5,
wherein: the address conversion unit embeds the partition identifier in upper bit of an address when converting the address information according to the partitions; and
the partition identifier adding unit extracts the partition identifier from the upper bit in the address information included in the packet.

7. The computing system according to claim 1,
wherein the chipset includes a partition initializing unit that receives an initialization request for a specific one of the partitions, and selectively removes the packet by the partition identifier added to the received packet.

8. The computing system according to claim 7,
wherein: the chipset includes a transmitting unit that transmits a request packet to request access to the processor core, the IO device, or the memory controller;
the partition identifier adding unit that, when the transmitting unit transmits the request packet, registers a transaction identifier and a corresponding partition identifier included in the request packet; and
the partition identifier adding unit that, when address information or issuer information is not included in a response packet received in response to the request packet, associates the request packet and the response packet by the transaction identifier and adds the corresponding partition identifier to the response packet.

9. The computing system according to claim 7,
wherein: the processor or the IO hub converts address information according to the partitions to which the processor core or the IO device of an issuer of the packet belongs; and
the partition identifier adding unit identifies the partition identifier from the address information included in the packet.

10. The computing system according to claim 9,
wherein: the processor or the IO hub embeds the partition identifier in upper bit of an address when converting the address information according to the partitions; and
the partition identifier adding unit extracts the partition identifier from the upper bit in the address information.

11. The computing system according to claim 7, further comprising:
an address conversion unit that converts the address information according to the partitions to which the IO device of an issuer of the packet belongs, in the link connecting the IO hub and the IO device,
wherein the partition identifier adding unit obtains the partition identifier from the address information included in the packet.

12. The computing system according to claim 11,
wherein: the address conversion unit embeds the partition identifier in upper bit of an address when converting the address information according to the partitions; and
the partition identifier adding unit extracts the partition identifier from the upper bit in the address information included in the packet.

13. A computing system comprising:
a processor including a processor core;
an IO hub including a link connecting an IO device; and
a memory controller including a memory; the processor, the IO hub and the memory controller being mutually connected by a chipset,
wherein the computing system is split into one or more partitions in each of which a virtual computer with an operating system run is operated, and the processor core or the IO device respectively belongs to the partitions; and
the chipset includes:
a receiving unit that receives a packet issued from the processor core or the IO device; and
a partition initializing unit that receives an initialization request for a specific one of the partitions, and performs initialization in units of partitions.

14. The computing system according to claim 13,
wherein the partition initializing unit, based on a partition identifier of the packet, selectively removes the packet corresponding to the partitions subjected to an initialization request.

15. A chipset that constitutes a computing system split into one or more partitions for operating a virtual computer with an operating system run, and mutually connects a processor including a processor core belonging to any of the partitions, an IO hub including a link connecting an IO device belonging to any of the partitions, and a memory controller including a memory,
wherein: the chipset includes at least one port control unit; and
the port control unit comprises:
a receiving unit that receives a packet issued from the processor core or the IO device; and
a partition initializing unit that receives an initialization request for a specific one of the partitions, and performs initialization in units of partitions.

16. The chipset according to claim 15,
wherein the partition initializing part of the port control part receives an initialization request for a specific one of the partitions, and selectively removes the received packet by a partition identifier of the packet.

17. The chipset according to claim 15,
wherein the port control unit, based on address information or issuer information included in the packet, identifies a partition to which the processor core or the IO device that issued the packet belongs, and adds a partition identifier corresponding to the identified partition to the packet.

18. The chipset according to claim 17,
wherein the partition initializing part of the port control part receives an initialization request for a specific one of the partitions, and selectively removes the received packet by the partition identifier added to the packet.

19. The chipset according to claim 17,
wherein: the port control unit includes a transmitting unit that transmits a request packet to request access to the processor core, the IO device, or the memory controller; and
the partition identifier adding unit of the port control unit, when the transmitting unit transmits the request packet, registers a transaction identifier and a corresponding partition identifier included in the request packet; and
the partition identifier adding unit of the port control unit, when address information or issuer information is not included in a response packet received in response to the request packet, associates the request packet and the response packet by the transaction identifier and adds the corresponding partition identifier to the response packet.

20. The chipset according to claim 17,
wherein the partition identifier adding unit of the port control unit identifies the partition identifier from the address information included in the received packet.
